(19) United States
(12) Patent Application Publication
(10) Pub. No.: US 2026/0245129 A1
(43) Pub. Date: Aug. 20, 2026

(54) DYNAMIC RESULT BOOSTING IN A CONSTRAINT BASED RETRIEVAL SYSTEM

(71) Applicant: Wynshop Enterprises Inc., Fort Lauderdale, FL (US)

(72) Inventors: Henry MICHAELSON, Durham, NC (US); Gabriel NIPOTE, Brooklyn, NY (US); Neeraj JOSHI, New York, NY (US); Brian WILLIAMS, Cary, NC (US); Neil MOSES, Aventura, FL (US); Spencer PRICE, Lakewood, CO (US)

(21) Appl. No.: 19/055,835

(22) Filed: Feb. 18, 2025

(51) Int. Cl. G06Q 30/0601

(52) U.S. Cl. CPC G06Q 30/0631; G06Q 30/0641

(57) ABSTRACT

Techniques for dynamic result boosting are provided. Embodiments include determining one or more attributes related to a user of a software application. Embodiments include generating, using a machine learning model, an initial ordered list of items based on the one or more attributes. Embodiments include automatically modifying the initial ordered list of items, based on a boosting factor associated with a particular item in the initial ordered list of items, and based on one or more boosting constraints, to produce a modified ordered list of items in which the particular item occupies a higher position than an initial position of the particular item in the initial ordered list of items. The one or more boosting constraints may relate to the initial position of the particular item in the initial ordered list of items. Embodiments include modifying a user interface based on the modified ordered list of items.

### INTRODUCTION

Aspects of the present disclosure relate to dynamic boosting of results retrieved for a consumer in a constraint based retrieval system that enables customizable automated computations of relevance according to both consumer related attributes and provider related attributes.

### BACKGROUND

Every year millions of people around the world utilize software applications to assist with countless aspects of life. For instance, a software application may allow users to view and interact with information, such as in connection with searching for content, products, or services through an online retrieval system. In one particular example, a software application may enable a user to submit an online order to be fulfilled by a retailer. The software application may, for example, include a user interface, and a user may interact with the user interface to search for, view, purchase, and/or otherwise interact with retrieved items. In some instances, the software application may automatically recommend substitute products for a selected product or automatically recommend other types of items (e.g., products, services, content, and/or the like). For example, the software application may generate such a recommendation using a machine learning model.

The machine learning model may, for instance, be a natural language processing (NLP) model (e.g., a Word2Vec model) that is pre-trained using a large corpus of text data from a variety of different sources (e.g., websites, books). Through this pre-training, the NLP model acquires general knowledge that may be applicable to a wide range of tasks, such as for generating vector representations (e.g., embeddings) of items for use in recommending items to a user (e.g., recommending substitute products for a selected product in an online order). In this manner, an NLP model may be used to determine substitute products to recommend for the selected product in the online order, such as based on comparing vector representations of the selected product and the substitute products. However, the substitute products or other items recommended using the NLP model may simply be other products or items assigned to the same category by the retailer. As a result, the NLP model may not consider other attributes of the selected product or item that may affect the relevancy of those other products or items in the same category as the selected product or item and of products or items in an entirely different category than the selected product or item. Thus, given the simplicity of the NLP model, the recommended substitute products for a selected product, or other recommended items, may be sub-optimal (e.g., not relevant).

As another example, the machine learning model may be trained using a large set of data. For example, the training data may include clickstream data for each of a plurality of different users (e.g., in the thousands) interacting with the software application to place online orders with the retailer or perform other types of operations. However, training the machine learning model using such a large training data set can be computationally intensive and, as a result, is generally undesirable.

Furthermore, existing automated recommendation techniques may involve “black box” algorithms that cannot be readily understood or controlled by providers of products, services, content, or other items. Software applications that do give some amount of control to providers with respect to recommendations generally involve reserving fixed recommendation “slots” for items that are sponsored or otherwise preferred by a provider. Such techniques provide relatively limited utility, and often involve disregarding relevance to the user in favor of provider preferences when generating certain automated recommendations (e.g., usually the first recommendation(s) displayed) in a software application. These techniques may result in irrelevant results being automatically selected as recommendations and/or may enable only a small amount of limited control of an automated recommendation process by a provider within a software application (e.g., overriding logic that would otherwise be used to generate automated recommendations for a one or more reserved slots).

Accordingly, there is a need in the art for improved techniques for automatically recommending items in software applications.

### BRIEF SUMMARY

Aspects and advantages of embodiments of the present disclosure will be set forth in part in the following description, or may be learned from the description, or may be learned through practice of the embodiments.

In one aspect, a method for dynamic result boosting in a software application is provided. The method generally includes: determining one or more attributes related to a user of the software application; generating, using a machine learning model, an initial ordered list of items based on the one or more attributes, wherein the machine learning model is configured to generate a relevance score for each item in the initial ordered list of items based on the one or more attributes; automatically modifying the initial ordered list of items, based on a boosting factor associated with a particular item in the initial ordered list of items, based on the relevance score for the particular item, and based on one or more boosting constraints, to produce a modified ordered list of items in which the particular item occupies a higher position than an initial position of the particular item in the initial ordered list of items, wherein the one or more boosting constraints relate to the initial position of the particular item in the initial ordered list of items; and modifying a user interface based on the modified ordered list of items.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment for dynamic result boosting in a software application according to some embodiments of the present disclosure.

FIG. 2A depicts an example of dynamic result boosting in a software application according to some embodiments of the present disclosure.

FIG. 2B depicts an example of dynamic multi-stage result boosting in a software application according to some embodiments of the present disclosure.

FIG. 3 depicts an example of training a machine learning model related to dynamic result boosting in a software application according to some embodiments of the present disclosure.

FIG. 4 depicts a user interface displaying recommended items to substitute for a selected item according to some embodiments of the present disclosure.

FIG. 5 depicts a flow diagram of a method for dynamic result boosting in a software application according to some embodiments of the present disclosure.

FIGS. 6A and 6B depict example processing systems according to some embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure relate to dynamic result boosting in a software application, such as in a constraint based retrieval system (e.g., a software application that automatically retrieves items to display to a user and automatically determines relevance of such items in a dynamic manner based on various constraints such as boosting constraints).

Example aspects of the present disclosure are directed to a machine learning and constraint based approach for automatically recommending items, such as substitute products for a target product (e.g., grocery product) in an online order, suggested content items based on attributes of a user and/or other content items viewed by the user, and/or the like. According to certain embodiments, a machine learning model is used to generate an initial ordered list of items based on one or more attributes (e.g., relating to a user and/or one or more items that the user has interacted with), and the initial ordered list is automatically modified according to dynamic boosting logic that is based on provider preferences, sponsorship, advertising amounts, and/or the like. Such boosting may be performed according to particular constraints or rules that allow a provider to configure and control an automated recommendation process that may otherwise be opaque (e.g., due to the nature of machine learning models) and that prevent or reduce the instances in which the automated recommendation process produces results that are inconsistent with provider preferences or user relevance, which are problems that often occur with existing automated recommendation techniques.

As described in more detail below, the boosting process may involve multiple stages that run sequentially, and each stage may include multiple boosting factors (which may also include burying factors) that are run in parallel with one another at that stage. For example, a first boosting stage may include applying boosting factors that relate to item attributes without regard to the positions of the items in the initial ordered list of items. A second boosting stage may begin after the first boosting stage completes, and may include applying boosting factors that relate to positions of the items in the ordered list output from the first boosting stage, such as relating to removing or reducing redundancy (e.g., item redundancy, category redundancy, and/or the like) in the ordered list. A third boosting stage may begin after the second boosting stage completes, and may include applying boosting factors that relate to promotional, advertising, and/or other provider-related factors to the ordered list output from the second boosting stage. Boosting constraints may apply to all boosting stages, and may ensure that all boosting logic complies with various limitations, such as relating to whether certain items are eligible for boosting and/or an extent to which items can be boosted.

While the present disclosure is focused on boosting techniques, a description is provided below of example techniques for generating the initial ordered list of items to which boosting logic may be applied.

### Generating the Initial Ordered List of Items Prior to Boosting

Various attributes related to a user and/or one or more items related to the user (e.g., a product selected by the user) may be used as inputs to a machine learning model in connection with generating an initial ordered list of items. In some embodiments, the disclosed techniques may include generating a hierarchical structure (e.g., ontology) representing normalized and highly-specific item categories based on different attributes (e.g., name, description, brand, retailer, producer, provider, genre, etc.) for each of a plurality of items associated with one or more providers (e.g., retailers, distributors, content providers, and/or the like). The hierarchical structure may include distinct elements arranged in a taxonomy (e.g., based on keywords included in category data provided by the different providers) for each of the plurality of items. The categories represented in the hierarchical structure may be examples of attributes.

In some embodiments, the items may be grocery products, and the distinct elements in the hierarchical structure may include, without limitation, a grocery product's essence attribute (e.g., highly specific category, such as dragon fruit), a grocery product's dietary/health attributes (e.g., vegan, vegetarian, gluten-free, etc.), a grocery product's marketing term attribute (e.g., organic, free range, premium, etc.), a grocery product's distribution method attribute (e.g., frozen, fresh, chopped, canned, etc.), a grocery product's sensory attribute (e.g., chocolate flavored, vanilla scented, caramel colored, etc.), and a grocery product's organization attribute (e.g., manufacturer, brand, parent company, etc.). The hierarchical structure may define taxonomy relationships between each distinct item. In this manner, the hierarchical structure may be used to determine a similarity score denoting how far away each item is from one another in the hierarchical structure.

The disclosed machine learning and constraint based approach may include generating training data for training a machine learning model (e.g., a light gradient boosted tree) to automatically recommend items (e.g., substitute products for a target product included in an online order). For instance, generating the training data may include generating a large subset of items (e.g., 20,000 items) for which the optimal related items (e.g., substitutes) are known. To generate the large subset of items, the disclosed techniques may include, for each product in the subset of products, generating a list of candidate substitute products. For example, generating the list of candidate substitute products may include obtaining, for each respective item in the subset of items, items that closely match (e.g., have a similarity score greater than a threshold value with respect to) the respective item's classification as defined in the hierarchical structure. Additionally, generating a list of candidate items for consideration by a machine learning model may include obtaining, for each respective item in the subset of items, items that are in the same category in which the respective item is categorized according to category data specified by one of the providers.

The disclosed machine learning and constraint based approach may include generating synthetic data using, for each respective item in the subset of items, a list of candidate items. For instance, the list of candidate items that are candidates to be recommended in relation to a respective item in the subset of items may be provided to a generative artificial intelligence model (e.g., different than the machine learning model) configured to rank the list of candidate items for the respective item from most relevant to least relevant. In some embodiments, the disclosed machine learning and constraint based approach may include, for each respective item in the subset of items, modifying the ranked list of candidate items based on previously selected items (e.g., substitutes) selected by particular users (e.g., personal shoppers, individuals hired on behalf of users, end-shoppers, and/or the like). Alternatively, or additionally, the ranked list of candidate items may be modified according to internal data that is based on historical item interaction data (e.g., associated with a plurality of different users) and is indicative of popular items (e.g., substitutes) with respect to each respective item in the subset of items.

The disclosed techniques may include training a machine learning model (e.g., a light gradient boosted tree) using, for each respective item in the subset of items, the ranked list of candidate items. For example, features associated with the respective item in the subset of items (and/or associated with users that historically interacted with the items) may be provided as input features to the machine learning model. Additionally, features associated with each of the candidate items included in the ranked list of candidate items generated by the generative artificial intelligence model may be provided as input features to the machine learning model. In some embodiments, the input features provided to the machine learning model may include one or more scores (e.g., generated using one or more other machine learning models) indicating a relationship between the respective item in the subset of items and each of the candidate items.

Based on the input, the machine learning model may generate an output that includes a predicted ranking (e.g., ordered list of items). The predicted ranking may include a ranking of the candidate items. The output (that is, the predicted ranking) of the machine learning model may be compared to a ground truth label, such as the output (that is, the ranked list) of the generative artificial intelligence model. More specifically, the ranked list generated using the generative machine learning model may be used as a ground truth list for training the machine learning model through a supervised learning process. For instance, parameters (e.g., weights) of the machine learning model may be iteratively adjusted based on variances between the predicted ranking generated by the machine learning model and the ranked list generated by the generative artificial intelligence model (e.g., until the predicted rankings generated by the machine learning model match the ranked list generated by the generative artificial intelligence model or until some other training condition occurs).

Once the machine learning model (e.g., light gradient boosted tree model) is trained, the machine learning model may be deployed to automatically recommend items in connection with target items (e.g. products included in an online order) and/or otherwise in connection with a user. For example, the machine learning model may be provided with attributes related to a user, such as a category and/or other attribute of an item associated with the user (e.g., an item selected by the user), user profile data, user preferences, and/or the like. The machine learning model may also, in some embodiments, be provided with a list of candidate items that are selected based on the hierarchical structure described above and/or otherwise based on similarity between the candidate items and a target item (e.g., the list of candidate items may include items that share a category with the target item, that share one or more other attributes with the target item, and/or that are otherwise determined to be similar to the target item, such as based on a similarity or relevance score computed using the hierarchical structure). In response to such inputs, the machine learning model may output a ranked list, such as an initial order list of items that may potentially be recommended to the user, such as in connection with the target item (e.g., as substitutes for the target item and/or otherwise as being related to the target item and/or to the user).

It is noted that the techniques described above for generating an initial ordered list of items are included as examples, and other techniques for generating the initial ordered list of items are possible. More generally, the initial ordered list of items may be generated based on one or more attributes associated with a user, such as including one or more attributes of an item selected by the user, and may be generated through the use of a machine learning model. In some embodiments, the machine learning model may output a relevance score for each item in the initial ordered list, such as indicating an amount of predicted relevance for each item with respect to the user and/or the target item. The order of the initial ordered list may correspond to such relevance scores, such as being ordered from the highest relevance score to the lowest relevance score. The initial ordered list may then be modified according to boosting logic as described below.

### Dynamic Constraint Based Boosting of Results in the Initial Ordered List of Items

In some embodiments, the disclosed techniques may include boosting certain items included in the output (e.g., the predicted ranked list, such as the initial ordered list of items) the machine learning model generated for the user, such as in connection with a given target item. For instance, in some embodiments, a particular item may be boosted (e.g., moved up in the list), buried (e.g., moved down in the list), or filtered (e.g., removed from the list) based, at least in part, on one or more attributes associated with the provider, such as one or more boosting factors, and according to one or more boosting constraints. For example, in some embodiments, items that are being promoted by a provider or that are associated with an advertising value (e.g., a cost per click) may be boosted (e.g., moved up) in the ordered list of items. Additionally, items that the user has previously selected, such as in connection with the target item may be boosted in the ordered list of items.

The amount that any item is boosted, buried, or filtered in the ordered list of items may be determined based on various criteria, such as a boosting factor (e.g., indicating an extent to which the item is being promoted, a cost per click, and/or the like) and one or more boosting constraints. For example, boosting constraints may enable a provider to configure and control the automated recommendation process through rules that govern the automated selection and ordering of items for recommendation. In one example, a boosting constraint comprises a rule indicating that any given item is not eligible for boosting unless it is within the top n percent (or otherwise above a threshold position or above a threshold relevance score) in the initial ordered list of items. Such a constraint may prevent a problem with existing automated recommendation systems in which promoted or advertised items may be automatically recommended to a user even when such items are not otherwise particularly relevant to the user or to a target item that a user has selected. Such a constraint may solve this problem by ensuring that items are only automatically boosted (e.g., moved up in the list) based on boosting factors (e.g., relating to promotion or advertising) if they have already been automatically determined to be sufficiently relevant to the user and/or to a target item.

In another example, a boosting constraint comprises a rule indicating that any given item is only permitted to be boosted a certain amount (e.g., no more than a threshold number of positions in the list or by no more than given percentage of the list) based on boosting factor(s). For example, such a constraint may prevent an item from being automatically boosted to a position that is overly reflective of promotional or advertising concerns and insufficiently reflective of relevance to the user and/or to the target item.

The extent to which a given item is boosted may be based on a value (e.g., an advertising value) indicated in a boosting factor. For example, if a boosting factor for a first item indicates a cost per click of two dollars and a boosting factor for a second item indicates a cost per click of one dollar, the first item may be boosted more heavily (e.g., may be moved up by a larger number of positions) than the second item (e.g., assuming the first item and the second item are otherwise equally eligible for boosting according to the boosting constraints).

Boosting may be performed in multiple stages that run sequentially, and each stage may involve applying one or more boosting factors (e.g., in parallel). Each boosting factor may potentially be applicable to one or more items in the list. All stages of boosting may be performed according to applicable boosting constraints.

In some cases, boosting of a given item at a given stage involves computing a modified relevance score for the given item based on an initial relevance score for the given item (e.g., that was output by the machine learning model or a previous boosting stage), a boosting factor associated with the given item (e.g., an advertising value, promotional amount, and/or the like), and one or more boosting constraints. For example, the initial relevance score for the given item may be increased by an amount that is proportional to the boosting factor (or by a set amount if the boosting factor does not indicate a numerical value) in view of any applicable boosting constraints. Then the modified relevance score of each item in the list for which the score was modified may be used to determine a modified ordered list of items (e.g., ordered according to the latest relevance score for each item, which may be a modified relevance score or an initial relevance score depending on whether the item's score has been modified). Other embodiments may not directly involve computation of relevance scores, and may instead involve moving items particular numbers of positions up or down in the ordered list based on the initial positions of the items, any applicable boosting factors, and any applicable boosting constraints.

In one particular example, there are three stages of boosting that run in sequence. At the first stage, one or more first boosting factors may be applied (e.g., in parallel) to the initial ordered list of items output by the machine learning model. The one or more first boosting factors may be “position independent” in that they are not based on the initial positions of the items in the ordered list. The first stage may involve running multiple boosting functions (e.g., which may include negative boosting functions or burying functions as well as positive boosting functions) in parallel, and these functions may be grouped together as they all are applied to items without any regard to their current position in the set of results. For example, the same bias may be applied to an item “x” whether it is in the first position or the last position in the initial ordered list. At the first boosting stage, what matters is what the attributes are for item “x” and what the attributes are that the current function is looking to boost or bury (and the respective values of said boost). This first boosting stage may include adjusting the ordering of the list based on item profit margin, item price, item brand, item stock keeping unit (SKU), item category (or sub category), item tag, item re-order likelihood, item to consumer affinity, item to current cart affinity, item to selected item (e.g., target item) affinity, item sales volume, item sales trend, and/or the like. All of these functions that adjust the position(s) of item(s) in the list may be run in parallel and all respective biases may be applied in a single step after all functions have produced an output of a rankings adjustment.

A second stage of boosting may involve “position dependent” boosting, and may run after the first boosting step has produced a first modified ordered list of items. The bias values determined at the second stage may be dependent on the positions of the items in the list after the position independent boosting step is applied. For example, one such boosting function may be to bury items (i.e., add a negative bias) where an item with the same category appears earlier in the set of results. For example, if there is first modified ordered list of items where an apple appears in the first position, a boosting (e.g., negative boosting, or burying) function at the second stage may move a second apple further down the list as it is redundant to the consumer. Other examples of boosting factors that may applied at the second stage include functions that bury redundant items (e.g., where the same item appears more than once), bury redundant brands, bury redundant categories, and/or the like. Another example of a boosting factor that may be applied at the second stage includes a boosting factor that is based on previously-selected items by the user, such as a boosting factor that buries items that are redundant in one or more ways (e.g., based on one or more item attributes) of one or more items previously selected by the user (e.g., if a user has already added an apple to the cart, it may be redundant to recommend additional apples or to recommend more than one additional apple). Another example of a boosting factor that may be applied at the second stage includes a boosting factor that is based on redundancy as determined through comparison of vector representations of items, such as burying items that are close in the vector space to other items that appear previously in the ordered list (e.g., such a factor may aim to maximize difference in the vector space). There are multiple types of such functions that may all run in parallel on the first modified ordered list of items (with relevance scores) returned from the position independent biasing step (e.g., the first stage). All of these position dependent biases may be combined after all functions at the second stage are completed, and a single list may be returned with adjusted rankings and relevance scores. It is noted that the position independent boosting factors (e.g., at the first stage) should be applied prior to the position dependent boosting factors (e.g., at the second stage) because redundancy should be identified and addressed after the position independent boosting is complete. The second stage may produce a second modified ordered list of items.

Lastly, a third stage of boosting may involve applying promotional, advertising, and/or other provider-specified biases, taking in the second modified ordered list of items that is returned from the second stage and performing an additional round of boosting where items are boosted based on attributes. This boosting may be based on, for example, third parties paying to have certain items or types of items advertised or promoted, and such third parties may be billed when a boosted item is viewed, added to cart, interacted with, purchased, and/or the like. In some embodiments, multiple boosting factors are applied in parallel at the third stage, such as based on a cost per click associated with a particular item, brand, type of item, and/or other item attribute(s). All of the biases determined at the third stage may be combined after all functions at the third stage are completed, and a single list may be returned with adjusted rankings and relevance scores. For example, each stage may involve computing updated relevance scores for the items in the list, and the list may be re-ordered according to the updated relevance scores. The third stage may produce a third modified ordered list of items (e.g., which may be referred to simply as a modified ordered list of items, since it is the final result of all boosting stages). Promotional or advertising based boosting may be performed last due to the high value of such boosting.

It is noted that items may also be associated with “negative” boosting factors, such as indicating that a particular item is disfavored by a provider and/or otherwise is not to be recommended (e.g., in connection with a particular target item or with a user having one or more particular attributes). In such cases, an item may be buried or filtered from the ordered list of items based on such a boosting factor, such as according to any applicable boosting constraints.

The modified ordered list of items that is generated based on performing any applicable boosting (and/or burying and/or filtering) of any items in the initial ordered list of items may then be used to display one or more item recommendations to the user, such as via a user interface displayed on a display screen associated with a user device. In some embodiments, the entire modified ordered list of items may be displayed to the user (e.g., in the order in which the items appear in the list). In other embodiments, one or more of the top items in the modified ordered list of items may be displayed to the user. For example, the top item in the modified ordered list of items may be displayed, the top n items in the modified ordered list of items may be displayed, and/or the like. In one particular example, the top item (or the top n items) is first displayed along with a user interface control that, when selected, causes additional items from the modified ordered list of items to be displayed (e.g., in the order in which the items appear in the list). For example, one or more items from the modified ordered list of items may be displayed as recommended substitutions for a target item selected by the user, such as if the target item is not available. In another example, one or more items from the modified ordered list of items may be displayed as recommended items that may be otherwise relevant to the user, whether in connection with a target item or not.

If the user selects a recommended item, that selection may be used as feedback to further improve the automated recommendation process. For example, the machine learning model may be re-trained based on the feedback, a boosting factor may be created based on the feedback (e.g., a boosting factor indicating that particular item is favored by that particular user and is to be boosted in the future, such as under similar circumstances such as in connection with a particular target item), and/or the like. Furthermore, if a user selects a recommended item that has promotional or advertising biasing applied to it (e.g., from the third stage of boosting), then such biasing may be tracked as part of invoicing a potential advertiser's campaign. For example, an invoice may be automatically generated and provided to a particular advertiser based on such selection(s) of recommended item(s) that have been boosted based on one or more promotional or advertising based boosting factor(s).

Example aspects of the present disclosure provide numerous technical improvements with respect to existing techniques for automated recommendation generation. For example, by enabling items to be automatically boosted in a dynamic manner according to dynamic boosting factors and according to configured boosting constraints, techniques described herein enable a provider to configure and control an automated recommendation process that may otherwise be based on “black box” models or algorithms, and prevent or reduce instances in which items that have little or no relevance to a particular user or target item are automatically recommended based exclusively on promotional or advertising factors. Thus, aspects of the present disclosure avoid automated generation of suboptimal recommendations and provide a more configurable and dynamic solution than techniques that are based only on machine learning models or fixed algorithms. Techniques described herein also may better use of computing resources such as display resources, such as by displaying item recommendations that are determined to be both relevant to a user and/or target item and also reflective of any applicable boosting factors such as promotional or advertising values, presenting the most relevant items first. On smaller user devices such as mobile phones with limited amounts of screen space, aspects of the present disclosure may provide particular technical benefits, ensuring that such limited screen space is used only for item recommendations that are most relevant to the user under the circumstances and that are most reflective of applicable provider considerations.

Furthermore, in some embodiments, by using the generative artificial intelligence model to generate synthetic data that is ultimately used to train a machine learning model (e.g., light gradient boosted tree) through transfer learning, certain techniques described herein significantly reduce the amount of training data that needs to be manually labeled. Additionally, in some embodiments, by training a machine learning model, such as a light gradient boosted tree or other similar type of machine learning model, based on outputs from a generative machine learning model (e.g., a large language model or other type of generative model) that may have a significantly larger number of parameters than the machine learning model, aspects of the present disclosure enable the smaller, lighter weight machine learning model to learn from the larger, heavier weight generative machine learning model and produce results with similar or higher accuracy while utilizing significantly fewer computing resources. Generally, by dynamically modifying an initial ordered list of items generated using a machine learning model based on boosting logic that is automatically governed by particular boosting constraints (e.g., limiting the circumstances under which items can be boosted, the extent to which items can be boosted, and/or the like), the disclosed techniques provide for personalized and configurable recommendations that are more relevant to a user and more reflective of provider considerations than recommendations generated by techniques implementing existing machine learning and/or reserved slot based approaches.

While certain existing techniques may involve automatically providing sponsored or advertised items via a user interface based only on lexical or categorical similarity between the sponsored or advertised items and a target item or other criteria, such existing techniques may result in providing irrelevant item recommendations. For example, while milk chocolate and chocolate milk may be associated with similar keywords and/or categories, a technique that resulted in displaying a promoted milk chocolate item in connection with a target chocolate milk item (e.g., in a reserved slot for promoted items or otherwise) would be performing sub-optimally. Aspects of the present disclosure overcome these deficiencies in existing automated item recommendation techniques by automatically boosting items in a dynamic manner according to dynamic boosting factors and according to configured boosting constraints, such as by only applying boosting logic to items that are first determined to be relevant through a dynamic automated relevance determination process (e.g., resulting in an initial ordered list of items) and through particular types of boosting constraints such as those related to a position of a given item in the initial ordered list (e.g., only boosting items that are already in a top portion of the initial ordered list and/or limiting boosting to no more than a threshold amount). Thus, techniques described herein result in a highly performant automated recommendation system that produces results that are both relevant and dynamically responsive to constraints and provider preferences.

### Machine Learning and Constraint Based Techniques for Automatically Recommending Items in a Software Application

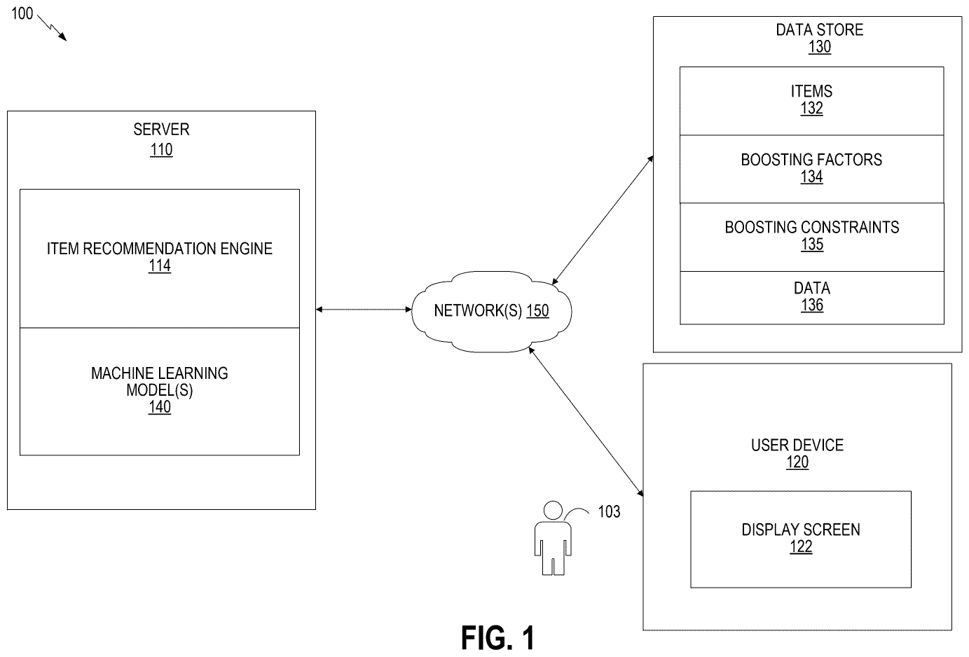

FIG. 1 depicts an example computing environment 100 for automatically recommending items in a software application according to some embodiments of the present disclosure.

The computing environment may include a server 110, a user device 120, and a data store 130, which may be connected to one another via one or more networks 150. Examples of the network(s) 150 may include a wide area network (WAN) or a local area network (LAN).

In some embodiments, the server 110 may be a computing device such as a server computer, and includes an item recommendation engine 114 and one or more machine learning models 140 (alternatively, one or more of machine learning models 140 may be located on a different device such a cloud server that is separate from server 110 and accessible via network(s) 150). Item recommendation engine 114 may be configured to automatically generate recommendations of items to provide to a user via a user interface, such as based on the use of a machine learning model 140 and dynamic boosting logic.

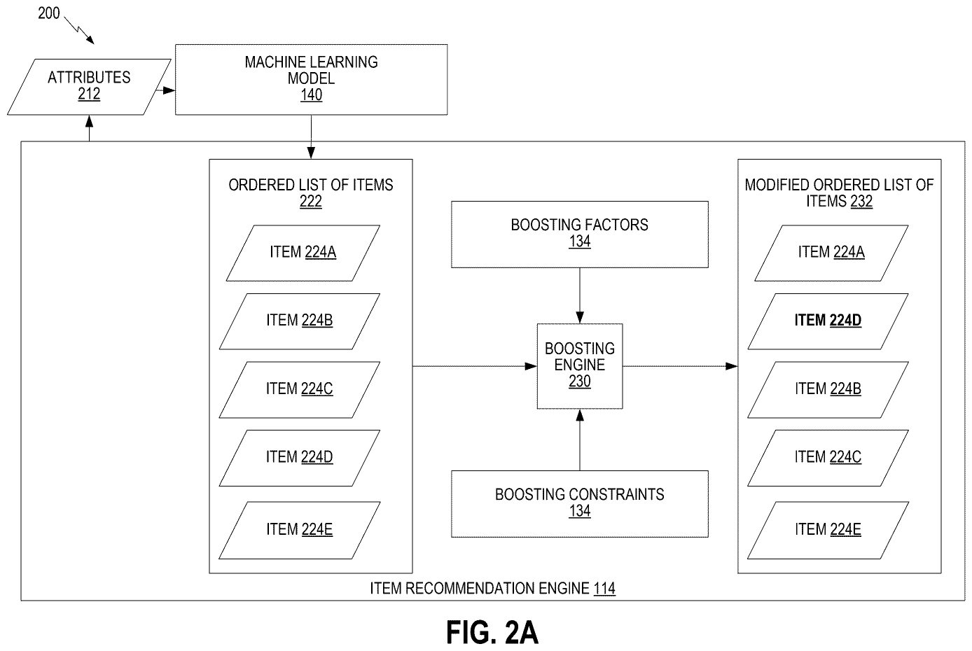

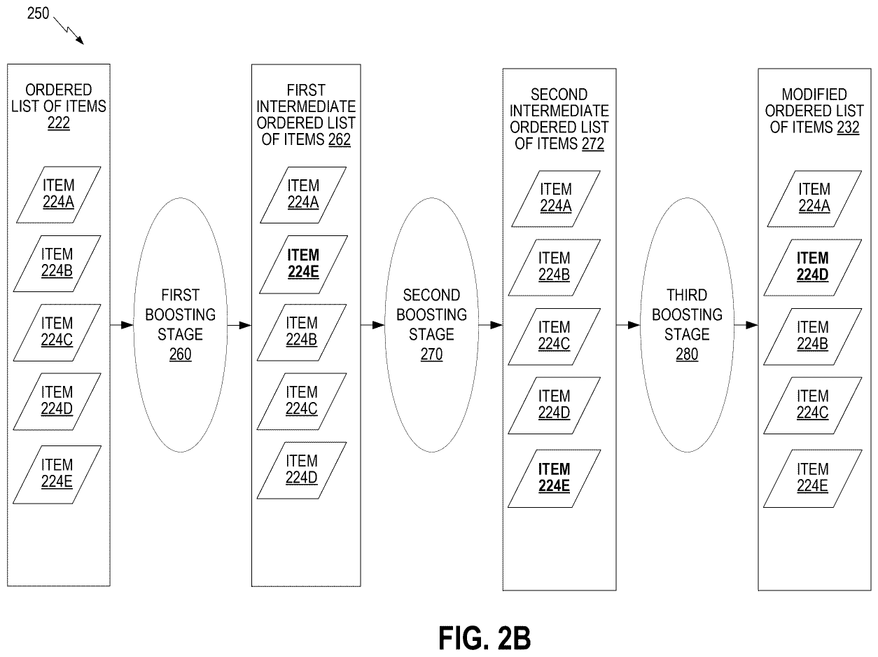

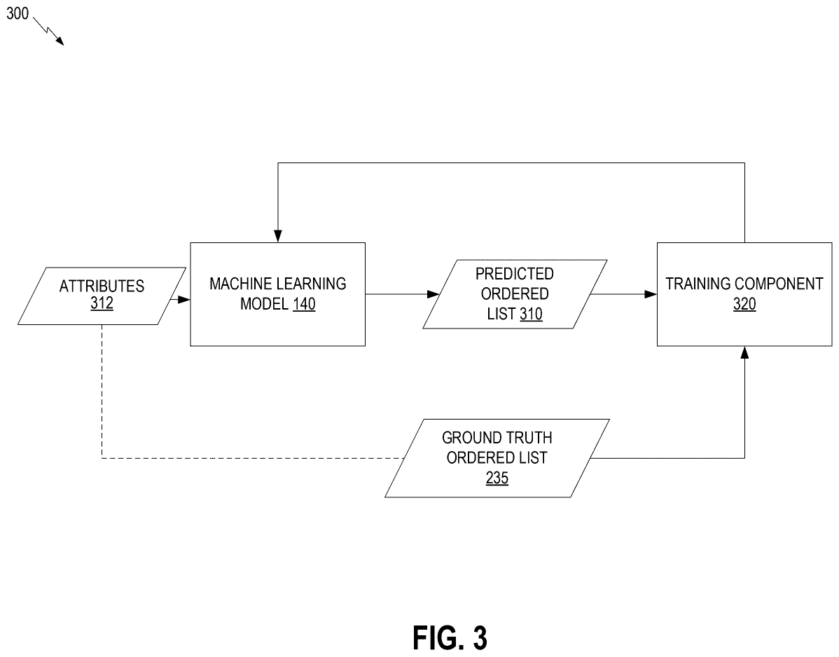

Machine learning model(s) 140 may, for example, include a machine learning model such as a light gradient boosted tree and/or a generative machine learning model such as a large language model (LLM), and/or one or more other types of machine learning models (e.g., a neural network, a random forest model, a regression model, a diffusion model, and/or the like). One or more of machine learning model(s) 140 may have been trained through a supervised learning process, as described in more detail below with respect to FIG. 3. For example, one of machine learning model(s) 140 may be a generative machine learning model that is used to generate synthetic training data (e.g., ordered lists of items associated with particular attributes) for use in training another one of machine learning model(s) 140, such as a lighter weight model with fewer parameters than the generative machine learning model. In such embodiments, a list of candidate items (e.g., candidates to be recommended in relation to a target item) may be provided to the generative machine learning model, such as along with attributes relating to a user and/or a target item, and the generative machine learning model may output an ordered list of the candidate items with respect to the target item from most relevant to least relevant. The candidate items may be identified based on the target item, such as including all items that are in a same category (e.g., in a hierarchical structure) as the target item or otherwise being determined to be within a threshold amount of similarity to the target item. The ordered list generated by the generative machine learning model may be used as a label for the attributes in a training data instance, and the training data instance may be used (e.g., along with other such training data instances) to train a machine learning model 140 (e.g., a light gradient boosted tree or other type of machine learning model that has fewer parameters than the generative machine learning model) through a supervised learning process. Once trained, the machine learning model 140 may be used to generate initial ordered lists of items, which may be modified according to boosting logic as described below with respect to FIG. 2A.

Data store 130 generally represents a data storage entity such as a database or repository, and generally stores data related to a software application that generates item recommendations via item recommendation engine 114 and machine learning model(s) 140. Data store 130 includes items 132, which generally represent items that can be recommended to and selected by a user, such as products, services, content items, user profiles, and/or the like. In one example, items 132 include products that can be purchased through an online store. In another example, items 132 include content items such as videos, images, articles, websites, or other types of content that can be recommended to and selected by a user.

Data store 130 includes boosting factors 134, which may be associated with particular items 132, particular item attributes, particular positions of items in an ordered list, and/or the like, and may indicate an extent to which each such item 132 is promoted, an advertising value of each such item 132, and/or other reasons that each such item 132 is favored for being recommended to a user. It is noted that boosting factors 134 may also include “negative” boosting factors, such as indicating the extent to which particular items should be buried or filtered. In one example, a boosting factor 134 indicates that a particular item 132 is associated with a particular cost per click (e.g., because an advertiser has agreed to pay the particular cost each time a user selects the particular item 132 or type of item after it is recommended to the user). In another example, a boosting factor 134 indicates that a given item 132 or item attribute is promoted (e.g., generally, without an indication of a particular extent to which the given item 132 is promoted). In yet another example, a boosting factor 134 indicates that a particular item 132 or item attribute is not to be recommended in connection with a particular target item from items 132 (and, thus, the particular item 132 is to be filtered out of any ordered list of items to recommend in connection with the particular target item). Boosting factors 134 may include boosting factors that are applied at multiple different sequential stages of boosting, such as boosting factors applied a first stage (e.g., position independent boosting), boosting factors applied at a second stage (e.g., position dependent boosting factors), and boosting factors applied at a third stage (e.g., promotional and/or advertising based factors). Examples of boosting factors 134 that may applied at the first stage include factors based on item profit margin, item price, item brand, item stock keeping unit (SKU), item category (or sub category), item tag, item re-order likelihood, item to consumer affinity, item to current cart affinity, item to selected item (e.g., target item) affinity, item sales volume, item sales trend, and/or the like. Examples of boosting factors 134 that may be applied at the second stage, following completion of the first stage, include factors based on redundant items, redundant item brands, redundant item categories, and/or other redundant item attributes. Examples of boosting factors 134 that may be applied at the third stage, following completion of the second stage, include factors based on promotion or advertisement by a provider or other third party of items, item categories, and/or other item attributes. Multi-stage boosting is described in more detail below with respect to FIG. 2B.

Data store 130 also includes boosting constraints 135, which generally represent rules that govern the boosting of items. Boosting constraints 135 may be configured by a provider, such as retailer, distributor, search platform, content provider, and/or the like, and may specify conditions under which items are eligible for boosting, the extent to which items can be boosted, and/or the like. In one example, a boosting constraint 135 indicates that any given item is only eligible for boosting if it is in the top n percent of or above a threshold position within an initial ordered list of items (e.g., an ordered list generated by a machine learning model 140 and/or otherwise based on relevance to a user and/or a target item). In another example, a boosting constraint 135 indicates that any given item is only permitted to be boosted a certain amount, such as no more than a threshold number of positions within the initial ordered list of items, by no more than a threshold percentage of the initial ordered list of items, and/or the like. Boosting constraints 135 may generally be applicable to all stages of boosting.

Data store 130 also includes data 136, which may correspond to other data associated with items and users. Data 136 may include any sort of data that is used to determine which items are most likely to be relevant to a particular user and/or with respect to a particular target item. For example, data 136 may include price data and/or user purchase data that indicates that an item is frequently selected in connection with another item. Data 136 may also include user attributes, such as geographic location information, user preferences, past user item selections (e.g., indicating an affinity of a user with respect to a particular item, such as in connection with a particular target item), and/or the like. Data 136 may also include information about items 132, such as classification information. In one example, data 136 includes a hierarchical structure (e.g., ontology) representing normalized and highly-specific item categories based on different attributes (e.g., name, description, brand, retailer, producer, provider, genre, etc.) for each item 132. The hierarchical structure may include distinct elements arranged in a taxonomy (e.g., based on keywords included in category data provided by the different providers) for each of the plurality of items 132. The categories represented in the hierarchical structure may be examples of attributes.

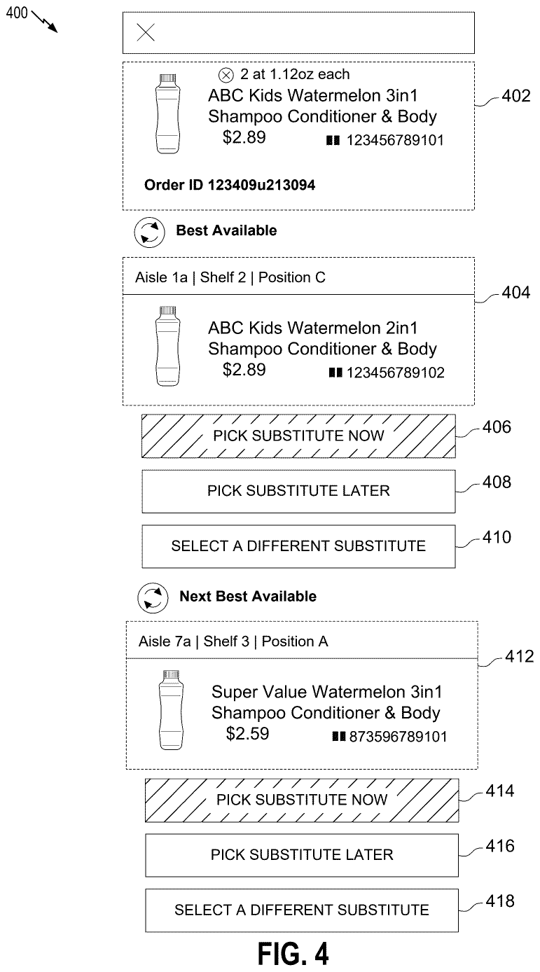

User device 120 generally represents a computing device such as a personal computer, mobile device, and/or the like. User device 120 includes a display screen 122 by which a user 103 may interact with a user interface associated with item recommendation engine 114. For example, the user may use a web browser or other software application on user device 120 to interact with a software application running on server 110, such as a software application that includes item recommendation engine 114. An example of a user interface screen that may be displayed on display screen 122 is described in more detail below with respect to FIG. 4.

Although certain examples discussed herein involve providing recommendations for substitute products for target products (e.g., in connection with online shopping), it is noted that such use cases are given as examples, and recommendations for other types of items may be generated as well.

### Example Machine Learning and Constraint Based Automated Generation of Item Recommendations

FIG. 2A is an illustration 200 of an example of dynamic result boosting in a software application according to some embodiments of the present disclosure. In particular, FIG. 2A depicts functionality associated with item recommendation engine 114 of FIG. 1.

Item recommendation engine 114 may provide attributes 212 to a machine learning model 140 (e.g., a light gradient boosted tree or other type of machine learning model that has been trained as described above and/or below with respect to FIG. 3), such as in connection with a particular user and/or a particular target item. Attributes 212 may include, for example, an identifier of a target item, a classification of the target item (e.g., a classification associated with a hierarchical structure), other characteristics of the target item such as indicators (e.g., labels) that indicate a price of the target item, a smell of the target item, a taste/flavor of the target item, how the target item was prepared (e.g., whether the target product is organic, canned/fresh, cooked/raw, and/or the like), a manufacturer of the target item, the contents of the target item, other categories (such as retailer-specific categories), a genre of the target item, and/or the like. Attributes 212 may also or alternatively include indication(s) of what items have historically been selected in connection with (e.g., as substitutes for) the target item, such as historical user selection data that indicates the frequency with which various items were selected in connection with the target item by one or more users. Attributes 212 may also or alternatively include user attributes such as geographic location information, user preferences, user affinity for particular items (e.g. indicating that a particular user has previously selected one or more particular items in connection with the target item), and/or the like.

In some embodiments, item recommendation engine 114 may further provide machine learning model 140 with one or more candidate items along with attributes 212. For example, item recommendation engine 114 may determine a set of candidate items based on the user and/or the target item, such as selecting candidate items that are within a same category or classification (e.g., within a hierarchical structure) as the target item and/or that are otherwise determined to be within a threshold amount of similarity with respect to the target item (e.g., based on one or more hierarchical structures that indicate relationships among item classifications and/or otherwise based on shared item attributes) and/or that are associated with attributes of the user. The hierarchical structure(s) may include one or more structures, such as knowledge graphs, that represent ontological relationships between items. Target items within a hierarchical structure may be associated with other items with which the target item shares a characteristic. For example, types of fruit may be relationally associated with other types of fruit. Within a fruit category, apples may be associated with other types of apples. Thus, a data structure may indicate that a pear is associated with an apple, and a pear may be identified as a candidate substitute for an apple. As another example, a data structure may indicate that a Honeycrisp apple is associated with a Fuji apple, and a Honeycrisp apple may be identified as a candidate substitute for a Fuji apple. Candidate items may also be determined based on other data, such as data that indicates organization of items based on aisle, department, section, category, classification, and/or the like. For example, if the target item is located in a particular aisle (e.g., the cereal aisle), all items located within the same aisle may be retrieved. The set of candidate items may be provided to machine learning model 140 as candidates from which machine learning model 140 is to select, based on attributes 212, to generate an initial ordered list of items 222.

Ordered list of items 222 generally represents an initial ordered list of items 224A-E based on attributes 212 and, in some embodiments, based on candidate items provided to machine learning model 140. For example, items 224A-E may have been included in a set of candidate items provided by item recommendation engine 114 to machine learning model 140 along with attributes 212, and ordered list of items 222 output by machine learning model 140 (e.g., in response to those inputs) may comprise items 224A-E in a particular order, such as from most relevant to least relevant. In some embodiments, ordered list of items 222 also includes a relevance score for each of items 224A-E, and the order of the items in the list may be according to the relevance scores.

A boosting engine 230 of item recommendation engine 114 may then perform boosting of one or more items in ordered list of items 222 based on one or more boosting factors 134 and according to one or more boosting constraints 134 to produce a modified ordered list of items 232. The boosting performed by boosting engine 230 may involve multiple stages of boosting that are run sequentially, with each stage including multiple boosting functions that apply different boosting factors in parallel with one another at the stage. Each stage may produce an iteratively modified ordered list of items that is provided as input to the next stage, with the output from the last stage being modified ordered list of items 232. Multi-stage boosting is described in more detail below with respect to FIG. 2B.

For example, boosting engine 230 may determine (e.g., at a third stage of boosting, after applying one or more position independent boosting factors at a first stage and then one or more position dependent boosting factors at a second stage) that a boosting factor 134 indicates that item 224D is associated with an advertising value, such as a cost per click. A boosting constraint 134 may, for example, comprise a rule that no item is to be boosted unless it is the top four positions of the initial ordered list (e.g., output by the machine learning model or the most recently completed stage of boosting) or within the top eighty percent of the initial ordered list (e.g., output by the machine learning model or the most recently completed stage of boosting). In the depicted example, boosting engine 230 may determine that item 224D is eligible for boosting based on this boosting constraint 134, and may boost item 224D accordingly. Another boosting constraint 134 may indicate that no item is permitted to be boosted by more than two positions. Thus, even though the boosting factor 134 may be high, and may otherwise have resulted in item 224D being boosted by more than two positions, boosting engine 230 may instead boost item 224D by only two positions (e.g., the maximum number of positions possible under boosting constraints 134). Thus, in modified ordered list of items 232, item 224D has been boosted by two positions relative to the position of item 224D in the initial ordered list of items 222 (e.g., instead of being the fourth position, as in ordered list of items 222, item 224D is in the second position in modified ordered list of items 232). While existing techniques that involve reserved slots may have resulted in item 224D being placed in the first position (e.g., which may have been a reserved slot for promoted or advertised items), techniques described herein may result in item 224D being boosted to a higher position than it would otherwise have occupied based only on user and/or target item relevance while still not being boosted to an extent that is not reflective of the relevance of item 224D to the user and/or target item. Thus, item 224A, which may not be associated with a boosting factor 134 or which may be associated with a smaller boosting factor 134 than that associated with item 224D, still occupies the first position in modified ordered list of items 232 due to its high level of relevance to the user and/or target item.

In some embodiments, boosting that is based on promotional or advertising related boosting factors may involve, rather than moving an original instance of a boosted item up in the ordered list, adding an additional instance of the boosted item to the ordered list in a higher position than the original instance of that item in the ordered list. Such a technique may enable more effective tracking of which items were boosted for promotional or advertising purposes, thereby enabling better determinations of when an advertiser should be invoiced for a user selection of or other type of interaction with a boosted item. This is because if an item appears in a high position in the ordered list for reasons other than promotional or advertising based boosting (e.g., based on original relevance determinations and/or boosting performed at the first stage or second stage) but also received promotional or advertising based boosting, it may be difficult to determine whether a user interaction with the item should trigger invoicing of the advertiser. However, if a new, additional instance of the item is added to the list in a relatively higher position based on promotional or advertising based boosting, then any interaction with this additional instance of the item is clearly attributable to the promotional or advertising based boosting, and the advertiser can be invoiced accordingly. In such a case, if a user interacts with the original instance of the item (e.g., which may be in a lower position in the ordered list), then such an interaction may not trigger invoicing of the advertiser, as that original instance was not selected for display based on promotional or advertising based boosting. Thus, “boosting” of an item may refer in some cases to adding an additional instance of the item to the ordered list, such as in a higher position than the original instance of the item. For example, a relevance score of the additional instance of an item may be higher than a relevance score of the original instance of the item as a result of the promotional or advertising based boosting, and so the additional instance of the item may appear higher in the ordered list than the original instance of the item. Generally, an item may only be added to the ordered list based on promotional or advertising based boosting if an original instance of the item already appeared in the ordered list prior to such boosting, which ensures that all such boosted items are relevant to the consumer and not merely promoted based on provider or third-party preferences.

Certain embodiments provide that the machine learning model 140 may be trained based on supervised, unsupervised or semi-supervised learning techniques. Supervised learning techniques generally involve providing training inputs to a machine learning model. The machine learning model processes the training inputs and outputs predictions based on the training inputs. The predictions are compared to known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Model parameters adjusted during training may include, for example, hyperparameters, values related to numbers of iterations, weights, functions used by nodes to calculate scores, level of randomness, and/or the like. In some embodiments, validation and testing are also performed for a machine learning model, such as based on validation data and test data, as is known in the art.

FIG. 2B is an illustration 250 of an example of dynamic multi-stage result boosting in a software application according to some embodiments of the present disclosure. In particular, FIG. 2B depicts functionality associated with item recommendation engine 114 of FIG. 1, and may represent a more granular view of functionality described above with respect to boosting engine 230 of FIG. 2A. Illustration 250 includes the initial ordered list of items 222 and the modified ordered list of items 232 of FIG. 2A. The multi-stage boosting process described is included as an example, and other processes with more or fewer stages are possible.

At the first boosting stage, one or more first boosting factors may be applied (e.g., in parallel) to the initial ordered list of items 222. The one or more first boosting factors applied at first boosting stage 260 may be “position independent” in that they are not based on the initial positions of the items in the ordered list. The first boosting stage 260 may include adjusting the ordering of the list based on item attributes such as item profit margin, item price, item brand, item stock keeping unit (SKU), item category (or sub category), item tag, item re-order likelihood, item to consumer affinity, item to current cart affinity, item to selected item (e.g., target item) affinity, item sales volume, item sales trend, and/or the like. All of the functions that adjust the position(s) of item(s) in the list at first boosting stage 260 may be run in parallel and all respective biases may be applied in a single step after all functions have produced an output of a rankings adjustment. First boosting stage 260 results in a first intermediate ordered list of items 262, in which the positions (and/or relevance scores) of one or more items have been modified as compared to the initial ordered list of items 222. In the depicted example, first boosting stage 260 resulted in in item 224E from the initial ordered list of items 222 being boosted from the fifth position to the second position in first intermediate ordered list of items 262, such as based on one or more attributes related to item 224E. For example, item 224E may have been boosted at first boosting stage 260 because item 224E has a profit margin above a threshold and based on such boosting being compliant with one or more boosting constraints (e.g., because item 224E is within a top n percent of the initial ordered list of items 222, because such boosting does not exceed a maximum number of positions that any given item can be boosted, and/or the like).

The second boosting stage 270 may involve “position dependent” boosting, and may run after the first boosting stage 260 has produced the first intermediate ordered list of items 262. The bias values determined at the second boosting stage 270 may be dependent on the positions of the items in the list after first boosting stage 260 step is applied. For example, one such boosting function may be to bury items (i.e., add a negative bias) or filter items where an item with the same category appears earlier in the set of results. There are multiple types of such functions that may all run in parallel on the first intermediate ordered list of items 262 (with relevance scores) returned from the position independent biasing step (e.g., the first boosting stage 260). All of these position dependent biases may be combined after all functions at the second boosting stage 270 are completed, and a single list, second intermediate ordered list of items 272, may be returned with adjusted rankings and relevance scores. In the depicted example, second boosting stage 270 results in item 224E being buried from the second position in first intermediate ordered list of items 262 to the fifth position in second intermediate ordered list of items 272, such as based on a determination that item 224E is redundant of item 224A in one or more respects (e.g., item 224E may be a variant of item 224A within the same category, such as a multipack version of the same item).

Lastly, the third boosting stage 280 may involve applying promotional, advertising, and/or other provider-specified biases, taking in the second intermediate ordered list of items 272 that is returned from the second boosting stage 270 and performing an additional round of boosting where items are boosted based on attributes. This boosting at third boosting stage 280 may be based on, for example, third parties paying to have certain items or types of items advertised or promoted, and such third parties may be billed when a boosted item is viewed, added to cart, interacted with, purchased, and/or the like. In some embodiments, multiple boosting factors are applied in parallel at the third boosting stage 280, such as based on a cost per click associated with a particular item, brand, type of item, and/or other item attribute(s). All of the biases determined at the third boosting stage 280 may be combined after all functions at the third stage are completed, and a single list may be returned with adjusted rankings and relevance scores, such as modified ordered list of items 232. In the depicted example, third boosting stage 280 results in item 224D being boosted from the fourth position in second intermediate ordered list of items 272 to a second position in modified ordered list of items 232, such as based on a boosting factor indicating that item 224D is associated with an advertising value, such as a cost per click, and based on such boosting being compliant with one or more boosting constraints.

In some cases, each of first boosting stage 260, second boosting stage 270, and third boosting stage 280 may involve computing updated relevance scores for the items in the list, and the list may be re-ordered according to the updated relevance scores.

### Example Model Training

FIG. 3 is an illustration 300 of an example of training a machine learning model related to dynamic result boosting in a software application according to some embodiments of the present disclosure. In particular, FIG. 3 depicts a training process for training a machine learning model 140 used to generate an initial ordered list of items such as ordered list of items 222 of FIG. 2A or FIG. 2B.

The machine learning model 140 may generally include any type of machine learning model that is capable of generating an ordered list of items and/or of outputting relevance scores for items based on particular input attributes. In some embodiments, the machine learning model 140 may include a gradient-boosted tree model, such as a LightGBM (Light Gradient-Boosted Machine) model. The machine learning model 140 may have a smaller number of parameters and/or may otherwise be less computationally costly to operate than a generative machine learning model that may be used to generate synthetic training data in some embodiments.

For example, a training data instance may include attributes 312 associated with a ground truth ordered list 235. Candidate items may also be included as training inputs in a training data instance. The training data may have been generated with the assistance of a generative machine learning model (e.g., that is prompted to output an ordered list of items based on attributes 312 and, in some embodiments, candidate items, and that outputs ground truth ordered list 235 in response) and/or based on manual review and/or input. For example, ground truth ordered list 235 may have been generated by an expert and/or may be based on user selection data indicating which items one or more users historically selected in connection with a target item (e.g., the target item may be represented by one or more of attributes 312). Ground truth ordered list 235 generally represents an ordered list of items that has been confirmed, either through manual or automated (e.g., by a generative machine learning model) review, to accurately reflect an order of relevance with respect to the user and/or target item represented by attributes 312. For example, attributes 312 may include the same types of attributes as attributes 212 of FIG. 2A.

As part of the training of machine learning model 140, attributes 312 (and, in some embodiments, candidate items) may be provided to machine learning model 140 as training inputs. The input may include candidate scores 305. Based on the input(s), machine learning model 140 may generate an output that includes predicted ordered list 310. The predicted ordered list 310 may include an ordered list of items (e.g., the items included in the candidate items), such as from most relevant to least relevant, and, in some embodiments, may include relevance scores for each item in the list. Training component 320 may then compare the predicted ordered list 310 to the ground truth ordered list 235, such as via a cost function. Parameters of machine learning model 140 may be iteratively adjusted based on variances between the predicted ordered list 310 and the ground truth ordered list 235 (e.g., until an output generated by the machine learning model 140 matches the ground truth ordered list 235 and/or another condition is met, such as relating to optimization of a cost function).

The training process described with respect to illustration 300 may be performed at regular intervals and/or whenever one or more conditions occur, such as when a threshold amount of new training data instances become available. New training data instances may be generated when user feedback is received, such as when a user selects a particular item (e.g., in connection with a particular target item), and such user feedback based training data instances may be used to re-train machine learning model 140 for ongoing improvements in performance. In some cases, if a user selects an item that was recommended based on an output generated by machine learning model 140, that user feedback may be taken as confirmation that the output from machine learning model 140 was correct (e.g., at least with respect to the selected item), and the output from machine learning model 140 (or at least the portion that includes the selected item) may be used as a ground truth label in a new training data instance that is used to re-train machine learning model 140.

### Example User Interface Displaying Recommended Items

FIG. 4 depicts a user interface 400 according to some embodiments of the present disclosure. For example, the user interface 400 may be displayed on a display screen (e.g., display screen 122 of FIG. 1) of a user device.

As illustrated, the user interface 400 may display information 402 for an item selected by a user. For example, the information 402 may include a price of the item as well as a textual description of the item. The information 402 may also include an Order identifier (ID) associated with the selected item and a universal product code (UPC) number (e.g., a 12-digit number) assigned to the selected item.

The user interface 400 may also display information 404 for a recommended item in connection with the item selected by the user, such as a recommended substitute for the selected item. For example, the information 404 may include a price of the recommended item as well as a textual description of the recommended item. The information 404 may also include a UPC number assigned to the recommended item. Information 404 may, for example, correspond to a top item in modified ordered list of items 232 of FIG. 2A.

The user interface 400 may include user controls 406, 408, 410 that a user may interact with (e.g., select) to perform various actions in the user interface 400. For example, the user may interact with user control 406 (e.g., labeled “Pick Substitute Now”) to replace the selected item with the recommended item. Alternatively, the user may interact with user control 408 (e.g., labeled “Pick Substitute Later”) to defer selection of a substitute item for the selected item. The user may interact with user control 410 (e.g., labeled “Select a Different Substitute”) to see a different substitute item for the selected item. For example, by selecting user control 410, the user may cause the user interface 400 to display a next best available recommended item or items included in the modified ordered list of items with resect to the selected product as determined using techniques described herein. In some embodiments, selection of user interface control 410 causes information 412 to be displayed along with user interface controls 414, 416, and 418. Alternatively, information 412 and user interface controls 414, 416, and 418 may be displayed without user interface control 410 being selected. For example, user interface control 410 may, when selected, cause a list of recommended items to be displayed (e.g., including the one or more next highest items in the modified ordered list of items).

The user interface 400 may display information 412 for another recommended item in connection with the item selected by the user, such as another recommended substitute for the selected item. For example, the information 412 may include a price of the other recommended item as well as a textual description of the other recommended item. The information 412 may also include a UPC number assigned to the other recommended item. Information 412 may, for example, correspond to a second highest item in modified ordered list of items 232 of FIG. 2A.

The user interface 400 may include user controls 414, 416, and 418 that a user may interact with (e.g., select) to perform various actions in the user interface 400. For example, the user may interact with user control 414 (e.g., labeled “Pick Substitute Now”) to replace the selected item with the other recommended item. Alternatively, the user may interact with user control 416 (e.g., labeled “Pick Substitute Later”) to defer selection of a substitute item for the selected item. The user may interact with user control 418 (e.g., labeled “Select a Different Substitute”) to see a different substitute item for the selected item (e.g., the third highest item in modified ordered list of items 232 of FIG. 2A). For example, by selecting user control 418, the user may cause the user interface 400 to display a next best available recommended item or items included in the modified ordered list of items with respect to the selected product as determined using techniques described herein.

### Example Operations for Dynamic Result Boosting in a Software Application

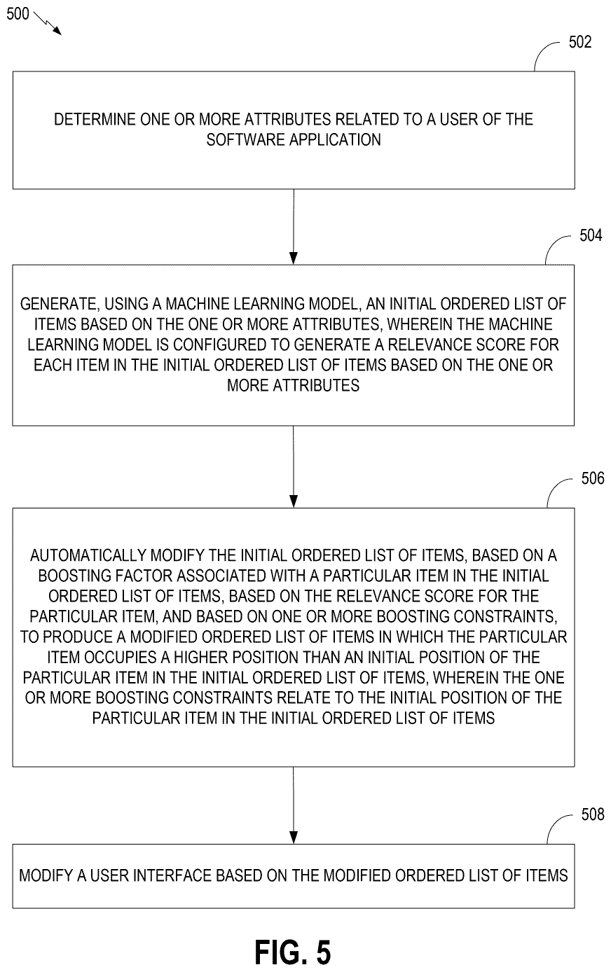

FIG. 5 is a flow diagram of example operations 500 for dynamic result boosting in a software application, according to some embodiments of the present disclosure. Operations 500 may be performed by instructions executing on a processor of a server (such as the server 110 of FIG. 1), such as being performed by item recommendation engine 114 of FIG. 1.

Operations 500 may begin at step 502, with determining one or more attributes related to a user of the software application.

Operations 500 may continue at step 504, with generating, using a machine learning model, an initial ordered list of items based on the one or more attributes, wherein the machine learning model is configured to generate a relevance score for each item in the initial ordered list of items based on the one or more attributes. The relevance score for each item in the initial ordered list of items may refer to a numerical score (e.g., output by the machine learning model in connection with the initial ordered list of items) and/or to a position of the item in the initial ordered list of items.

Operations 500 may continue at step 506, with automatically modifying the initial ordered list of items, based on a boosting factor associated with a particular item in the initial ordered list of items, based on the relevance score for the particular item, and based on one or more boosting constraints, to produce a modified ordered list of items in which the particular item occupies a higher position than an initial position of the particular item in the initial ordered list of items, wherein the one or more boosting constraints relate to the initial position of the particular item in the initial ordered list of items. The relevance score may refer to a numerical score and/or to a position of

Operations 500 may continue at step 508, with modifying a user interface based on the modified ordered list of items.

In some embodiments, the boosting factor associated with the particular item comprises a configured advertising value, and the automatically modifying of the initial ordered list of items comprises computing an updated relevance score for the particular item based on the configured advertising value, the relevance score for the particular item, and the one or more boosting constraints.

In some embodiments, the configured advertising value comprises a cost per click associated with the particular item.

In certain embodiments, the one or more boosting constraints comprises a rule indicating that no given item that occupies a given initial position below a threshold position is eligible for boosting.

In some embodiments, the one or more boosting constraints comprises a rule that prevents boosting any given item more than a threshold number of positions.

In certain embodiments, the particular item occupies a lower position in the modified ordered list of items than a different item that is associated with a lower boosting factor than the boosting factor associated with the particular item based on the relevance score of the different item being higher than the relevance score of the particular item.

In some embodiments, the particular item occupies a lower position in the modified ordered list of items than a different item that is associated with no boosting factor based on the relevance score of the different item being higher than the relevance score of the particular item.

In certain embodiments, the determining of the one or more attributes related to the user of the software application comprises determining that the user has selected a given item via the user interface, and the modifying of the user interface based on the modified ordered list of items comprises displaying one or more items from the modified ordered list of items as recommended items in connection with the given item.

In some embodiments, the displaying of the one or more items from the modified ordered list of items as the recommended items in connection with the given item comprises selecting a specific item from the modified ordered list of items to display based on an order of the modified ordered list of items.

In some embodiments, the displaying of the one or more items from the modified ordered list of items as the recommended items in connection with the given item comprises displaying all items in the modified ordered list of items in an order of the modified ordered list of items.

In certain embodiments, the given item comprises a product or a service, and wherein the displaying of the one or more items from the modified ordered list of items as the recommended items in connection with the given item comprises displaying one or more recommended substitute products or one or more recommended substitute services for the product or the service.

In some embodiments, the one or more attributes related to the user of the software application comprises one or more of: an identifier of the given item that was selected by the user; a classification of the given item that was selected by the user; a preference of the user; location information associated with the user; or an affinity of the user with respect to an item in the initial ordered list of items.

In certain embodiments, the automatically modifying the initial ordered list of items is further based on a plurality of additional boosting factors that are applied across a plurality of sequential boosting stages. In some embodiments, the plurality of sequential boosting stages comprises: a first boosting stage in which a first set of boosting factors relating to item attributes are applied; a second boosting stage, performed after completion of the first boosting stage, in which a second set of boosting factors relating to item list positions are applied; and a third boosting stage, performed after completion of the second boosting stage, in which a third set of boosting factors, including the boosting factor associated with the particular item, relating to item promotion or advertisement are applied, wherein the modified ordered list of items is produced as a result of completing the third boosting stage.

In certain embodiments, the automatically modifying the initial ordered list of items comprises adding, to the modified ordered list of items, an additional instance of the particular item in the higher position and leaving an original instance of the particular item in the modified ordered list of items in the initial position of the particular item.

### Example Computing Systems

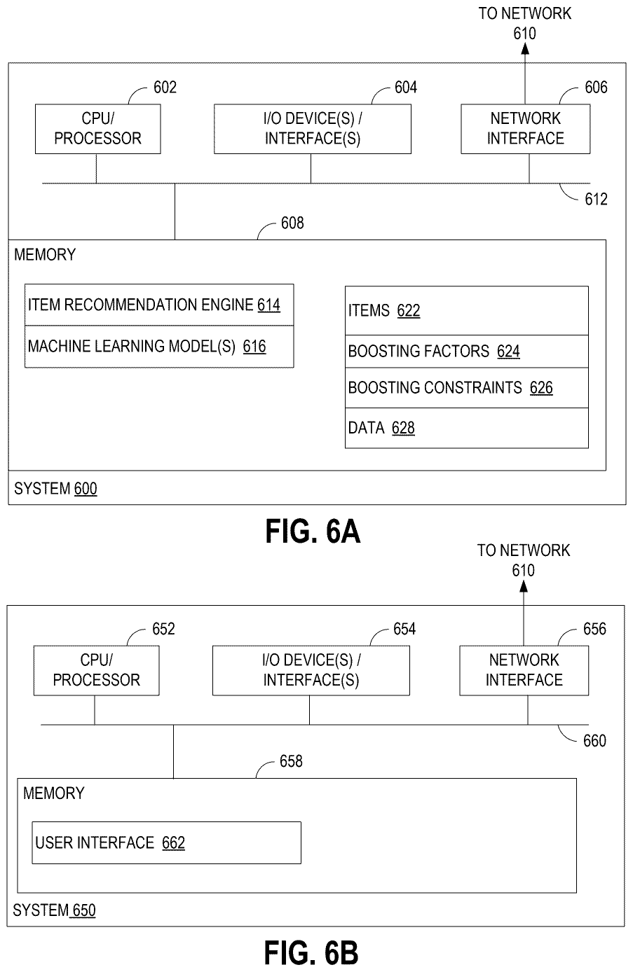

FIG. 6A illustrates an example computing system 600 with which embodiments of the disclosure related to dynamic result boosting in a software application may be implemented. For example, the computing system 600 may be representative of the server 110 of FIG. 1.

The computing system 600 includes a central processing unit (CPU) 602, one or more I/O device interfaces 604 that may allow for the connection of various I/O devices 604 (e.g., keyboards, displays, mouse devices, pen input, etc.) to the computing system 600, a network interface 606, a memory 608, and an interconnect 612. It is contemplated that one or more components of the computing system 600 may be located remotely and accessed via a network 610. It is further contemplated that one or more components of the computing system 600 may include physical components or virtualized components.

The CPU 602 may retrieve and execute programming instructions stored in the memory 608. Similarly, the CPU 602 may retrieve and store application data residing in the memory 608. The interconnect 612 transmits programming instructions and application data, among the CPU 602, the I/O device interface 604, the network interface 606, the memory 608. The CPU 602 is included to be representative of a single CPU, multiple CPUs, a single CPU having multiple processing cores, and other arrangements.

Additionally, the memory 608 is included to be representative of a random access memory or the like. In some embodiments, the memory 608 may include a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, the memory 608 includes item recommendation engine 614 (e.g., item recommendation engine 114 of FIG. 1), machine learning model(s) 616 (e.g., machine learning model(s) 140 of FIG. 1), items 622 (e.g., items 132 of FIG. 1), booting factors 624 (e.g., boosting engine 134 of FIG. 1), boosting constraints 626 (e.g., boosting constraints 135 of FIG. 1), and data 628 (e.g., data 136 of FIG. 1).

FIG. 6B illustrates an example computing system 650 with which embodiments of the disclosure related to dynamic result boosting in a software application may be implemented. For example, the computing system 650 may be representative of the user device 120 of FIG. 1.

The computing system 650 includes a central processing unit (CPU) 652, one or more I/O device interfaces 654 that may allow for the connection of various I/O devices 654 (e.g., keyboards, displays, mouse devices, pen input, etc.) to the computing system 650, a network interface 656, a memory 658, and an interconnect 660. It is contemplated that one or more components of the computing system 650 may be located remotely and accessed via the network 610. It is further contemplated that one or more components of the computing system 650 may include physical components or virtualized components.

The CPU 662 may retrieve and execute programming instructions stored in the memory 658. Similarly, the CPU 652 may retrieve and store application data residing in the memory 558. The interconnect 660 transmits programming instructions and application data, among the CPU 652, the I/O device interface 654, the network interface 656, the memory 658. The CPU 652 is included to be representative of a single CPU, multiple CPUs, a single CPU having multiple processing cores, and other arrangements.

Additionally, the memory 658 is included to be representative of a random access memory or the like. In some embodiments, the memory 658 may include a disk drive, solid state drive, or a collection of storage devices distributed across multiple storage systems. Although shown as a single unit, the memory 658 may be a combination of fixed and/or removable storage devices, such as fixed disc drives, removable memory cards or optical storage, network attached storage (NAS), or a storage area-network (SAN).

As shown, the memory 658 includes user interface 662 (e.g., user interface 400 of FIG. 4)

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of products refers to any combination of those products, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for dynamic result boosting in a software application, comprising:
determining one or more attributes related to a user of the software application;
generating, using a machine learning model, an initial ordered list of items based on the one or more attributes, wherein the machine learning model is configured to generate a relevance score for each item in the initial ordered list of items based on the one or more attributes;
automatically modifying the initial ordered list of items, based on a boosting factor associated with a particular item in the initial ordered list of items, based on the relevance score for the particular item, and based on one or more boosting constraints, to produce a modified ordered list of items in which the particular item occupies a higher position than an initial position of the particular item in the initial ordered list of items, wherein the one or more boosting constraints relate to the initial position of the particular item in the initial ordered list of items; and
modifying a user interface based on the modified ordered list of items.

2. The method of claim 1, wherein the boosting factor associated with the particular item comprises a configured advertising value, and wherein the automatically modifying of the initial ordered list of items comprises computing an updated relevance score for the particular item based on the configured advertising value, the relevance score for the particular item, and the one or more boosting constraints.

3. The method of claim 2, wherein the configured advertising value comprises a cost per click associated with the particular item.

4. The method of claim 1, wherein the one or more boosting constraints comprises a rule indicating that no given item that occupies a given initial position below a threshold position is eligible for boosting.

5. The method of claim 1, wherein the one or more boosting constraints comprises a rule that prevents boosting any given item more than a threshold number of positions.

6. The method of claim 1, wherein the particular item occupies a lower position in the modified ordered list of items than a different item that is associated with a lower boosting factor than the boosting factor associated with the particular item based on the relevance score of the different item being higher than the relevance score of the particular item.

7. The method of claim 1, wherein the particular item occupies a lower position in the modified ordered list of items than a different item that is associated with no boosting factor based on the relevance score of the different item being higher than the relevance score of the particular item.

8. The method of claim 1, wherein the determining of the one or more attributes related to the user of the software application comprises determining that the user has selected a given item via the user interface, and wherein the modifying of the user interface based on the modified ordered list of items comprises displaying one or more items from the modified ordered list of items as recommended items in connection with the given item.

9. The method of claim 8, wherein the displaying of the one or more items from the modified ordered list of items as the recommended items in connection with the given item comprises selecting a specific item from the modified ordered list of items to display based on an order of the modified ordered list of items.

10. The method of claim 8, wherein the displaying of the one or more items from the modified ordered list of items as the recommended items in connection with the given item comprises displaying all items in the modified ordered list of items in an order of the modified ordered list of items.

11. The method of claim 8, wherein the given item comprises a product or a service, and wherein the displaying of the one or more items from the modified ordered list of items as the recommended items in connection with the given item comprises displaying one or more recommended substitute products or one or more recommended substitute services for the product or the service.

12. The method of claim 8, wherein the one or more attributes related to the user of the software application comprises one or more of:
an identifier of the given item that was selected by the user;
a classification of the given item that was selected by the user;
a preference of the user;
location information associated with the user; or
an affinity of the user with respect to an item in the initial ordered list of items.

13. The method of claim 1, wherein the automatically modifying the initial ordered list of items is further based on a plurality of additional boosting factors that are applied across a plurality of sequential boosting stages.

14. The method of claim 13, wherein the plurality of sequential boosting stages comprises:
a first boosting stage in which a first set of boosting factors relating to item attributes are applied;
a second boosting stage, performed after completion of the first boosting stage, in which a second set of boosting factors relating to item list positions are applied; and
a third boosting stage, performed after completion of the second boosting stage, in which a third set of boosting factors, including the boosting factor associated with the particular item, relating to item promotion or advertisement are applied, wherein the modified ordered list of items is produced as a result of completing the third boosting stage.

15. The method of claim 1, wherein the automatically modifying the initial ordered list of items comprises adding, to the modified ordered list of items, an additional instance of the particular item in the higher position and leaving an original instance of the particular item in the modified ordered list of items in the initial position of the particular item.

16. A system for dynamic result boosting in a software application, comprising:
one or more processors; and
a memory comprising instructions that, when executed by the one or more processors, cause the system to:
determine one or more attributes related to a user of the software application;
generate, using a machine learning model, an initial ordered list of items based on the one or more attributes, wherein the machine learning model is configured to generate a relevance score for each item in the initial ordered list of items based on the one or more attributes;
automatically modify the initial ordered list of items, based on a boosting factor associated with a particular item in the initial ordered list of items, based on the relevance score for the particular item, and based on one or more boosting constraints, to produce a modified ordered list of items in which the particular item occupies a higher position than an initial position of the particular item in the initial ordered list of items, wherein the one or more boosting constraints relate to the initial position of the particular item in the initial ordered list of items; and
modify a user interface based on the modified ordered list of items.

17. The system of claim 16, wherein the boosting factor associated with the particular item comprises a configured advertising value, and wherein the automatically modifying of the initial ordered list of items comprises computing an updated relevance score for the particular item based on the configured advertising value, the relevance score for the particular item, and the one or more boosting constraints.

18. The system of claim 17, wherein the configured advertising value comprises a cost per click associated with the particular item.

19. The system of claim 16, wherein the one or more boosting constraints comprises a rule indicating that no given item that occupies a given initial position below a threshold position is eligible for boosting.

20. A non-transitory computer readable medium comprising instructions that, when executed by one or more processors of a computing system, cause the computing system to:
determine one or more attributes related to a user of a software application;
generate, using a machine learning model, an initial ordered list of items based on the one or more attributes, wherein the machine learning model is configured to generate a relevance score for each item in the initial ordered list of items based on the one or more attributes;
automatically modify the initial ordered list of items, based on a boosting factor associated with a particular item in the initial ordered list of items, based on the relevance score for the particular item, and based on one or more boosting constraints, to produce a modified ordered list of items in which the particular item occupies a higher position than an initial position of the particular item in the initial ordered list of items, wherein the one or more boosting constraints relate to the initial position of the particular item in the initial ordered list of items; and
modify a user interface based on the modified ordered list of items.
